(19) United States
(12) Patent Application Publication
(10) Pub. No.: US 2013/0124320 A1
(43) Pub. Date: May 16, 2013

(54) SYSTEM FOR ADVERTISING AND COMMUNICATING AT A VEHICLE CHARGING STATION AND METHOD OF USING THE SAME

(71) Applicant: Electric Transporation Engineering Corporation, d/b/a ECOtality North America, Phoenix, AZ (US)

(72) Inventor: Donald B. Karner, Phoenix, AZ (US)

(73) Assignee: Electric Transporation Engineering Corporation, d/b/a ECOtality North America, Phoenix, AZ (US)

(21) Appl. No.: 13/713,834

(22) Filed: Dec. 13, 2012

Related U.S. Application Data
(63) Continuation of application No. PCT/US2011/034667, filed on Apr. 29, 2011.
Application No. PCT/US2011/034667 is a continuation of application No. PCT/US2011/037587, filed on May 23, 2011.
Application No. PCT/US2011/037587 is a continuation of application No. PCT/US2011/037588, filed on May 23, 2011.
Application No. PCT/US2011/037588 is a continuation of application No. PCT/US2011/037590, filed on May 23, 2011.
Application No. PCT/US2011/037590 is a continuation of application No. PCT/US2011/034667, filed on Apr. 29, 2011.
Application No. PCT/US2011/034667 is a continuation of application No. PCT/US2011/034667, filed on Apr. 29, 2011.
(60) Provisional application No. 61/367,316, filed on Jul. 23, 2010.
(60) Provisional application No. 61/367,321, filed on Jul. 23, 2010.
(60) Provisional application No. 61/367,317, filed on Jul. 23, 2010.
(60) Provisional application No. 61/367,321, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,317, filed on Jul. 23, 2010.
(60) Provisional application No. 61/367,337, filed on Jul. 23, 2010.

(51) Int. Cl. G06Q 30/02

(52) U.S. Cl. CPC G06Q 30/0251
USPC 705/14.54; 705/14.66; 705/14.57

(57) ABSTRACT

In some embodiments, a system for advertising and communicating at a vehicle charging station and method of using the same as disclosed herein. Other embodiments of related systems and methods are also disclosed.

### CROSS-REFERENCE TO RELATED APPLICATIONS

This application is a continuation of: (a) International Patent Application Serial No. PCT/US2011/034667, filed Apr. 29, 2011, (b) International Patent Application Serial No. PCT/US2011/037587, filed May 23, 2011, (c) International Patent Application Serial No. PCT/US2011/037588, filed May 23, 2011, and (d) International Patent Application Serial No. PCT/US2011/037590, filed May 23, 2011. International Patent Application Serial No. PCT/US2011/034667, International Patent Application Serial No. PCT/US2011/037587, International Patent Application Serial No. PCT/US2011/037588, and International Patent Application Serial No. PCT/US2011/037590 each claim the benefit of: (1) U.S. Provisional Application Ser. No. 61/367,316, filed Jul. 23, 2010; (2) U.S. Provisional Application Ser. No. 61/367,321, filed Jul. 23, 2010; (3) U.S. Provisional Application Ser. No. 61/367,337, filed Jul. 23, 2010; and (4) U.S. Provisional Application Ser. No. 61/367,317, filed Jul. 23, 2010. Further, International Patent Application Serial No. PCT/US2011/037587, International Patent Application Serial No. PCT/US2011/037588, and International Patent Application Serial No. PCT/US2011/037590 each are a continuation of International Patent Application Serial No. PCT/US2011/034667. The disclosures of U.S. Provisional Application Ser. No. 61/367,316; U.S. Provisional Application Ser. No. 61/367,321; U.S. Provisional Application Ser. No. 61/367,337; U.S. Provisional Application Ser. No. 61/367,317; International Patent Application Serial No. PCT/US2011/034667, International Patent Application Serial No. PCT/US2011/037587, International Patent Application Serial No. PCT/US2011/037588, and International Patent Application Serial No. PCT/US2011/037590 are incorporated herein by reference in their entirety.

### STATEMENT REGARDING FEDERALLY SPONSORED RESEARCH OR DEVELOPMENT

This invention was made with U.S. Government support under Contract No. DE-EE00002194 awarded by the Department of Energy. The Government has certain rights in this invention.

### FIELD OF THE INVENTION

This invention relates generally to systems to operate with a charging station, and relates more particularly to such systems for providing charging and marketing information to users and methods of using the same.

### DESCRIPTION OF THE BACKGROUND

Charging a vehicle at a vehicle charging station can take a considerable amount of time. Likewise, the cost of charging a vehicle can vary considerably based on changes in the price of electricity throughout the day.

Accordingly, a need or potential for benefit exists for a system that provides users of vehicle charging stations with information and choices to optimize the cost of charging their vehicle while also providing the users with useful personal, vehicle, charger, public service, and marketing information while the users are waiting for their vehicles to charge.

### BRIEF DESCRIPTION OF THE DRAWINGS

To facilitate further description of the embodiments, the following drawings are provided in which:

FIG. 1 illustrates a representative block diagram for a system, according to one embodiment;

FIG. 2 illustrates a computer system that is suitable for implementing an embodiment of the system of FIG. 1;

FIG. 3 illustrates a representative block diagram of an example of the elements included in the circuit boards inside chassis of the computer system of FIG. 2;

FIG. 4 illustrates a method according to one embodiment;

FIG. 5 illustrates a representative block diagram for a system, according to one embodiment; and

FIG. 6 illustrates an exemplary electric vehicle charging station operating an embodiment of the system of FIG. 1.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

The term “real time” is defined with respect to operations carried out as soon as practically possible upon the occurrence of a triggering event. A triggering event can comprise receipt of data necessary to execute a task or to otherwise process information. Because of delays inherent in transmission and/or in computing speeds, the term “real time” encompasses operations that occur in “near” real time or somewhat delayed from a triggering event.

“Computer system,” as used herein, can refer to a single computer, a single server, or a cluster or collection of servers. Typically, a cluster or collection of servers can be used when the demands by client computers are beyond the reasonable capability of a single server or computer. In many embodiments, the servers in the cluster or collection of servers are interchangeable from the perspective of the client computers.

In some examples, a single server can include modules to perform various methods, procedures, processes, and activities. In other examples, a first server can include a first portion of these modules. One or more second servers can include a second, possibly overlapping, portion of these modules. In these examples, the computer system can comprise the combination of the first server and the one or more second servers.

In some embodiments, information received by the systems or during the methods of the present invention can be stored in a database such as an XML (Extensible Markup Language) database, a MySQL database, or an Oracle® database.

As used herein, “processor” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

In various embodiments, an operating system (OS) can be a software program that manages the hardware and software resources of a computer and/or a computer network. An operating system performs basic tasks such as, for example, controlling and allocating memory, prioritizing the processing of instructions, controlling input and output devices, facilitating networking, and managing files. Examples of common operating systems include Microsoft® Windows, Mac® OS, UNIX® OS, and Linux® OS. Common operating systems for a mobile device include the iPhone® operating system by Apple Inc. of Cupertino, Calif., the Blackberry® operating system by Research In Motion (RIM) of Waterloo, Ontario, Canada, the Palm® operating system by Palm, Inc. of Sunnyvale, Calif., the Android operating system developed by the Open Handset Alliance, the Windows Mobile operating system by Microsoft Corp. of Redmond, Wash., or the Symbian operating system by Nokia Corp. of Espoo, Finland.

### DETAILED DESCRIPTION OF EXAMPLES OF EMBODIMENTS

Some embodiments include a method of providing relevant information from a set of information. The method can be implemented via execution of computer instructions configured to run at one or more processing modules and configured to be stored at one or more non-transitory memory storage modules. The method can comprise: executing one or more first computer instructions configured to receive the set of information, wherein the set of information comprises at least one unit of marketing information indexed according to at least one selection category, the at least one selection category relating to at least one potential factor, and the at least one potential factor comprising at least one of: (a) at least one potential operating condition of an electric vehicle supply equipment, (b) at least one potential element of user data of an user profile, or (c) at least one potential user input; executing one or more second computer instructions configured to receive at least one of: (a) at least one actual operating condition of the electric vehicle supply equipment, (b) at least one actual element of user data of the user profile, or (c) at least one actual user input; if the at least one potential factor comprises the at least one potential operation condition of the electric vehicle supply equipment and if the at least one actual operating condition of the electric vehicle supply equipment is received, executing one or more third computer instructions configured to match the at least one actual operating condition with one or more of the at least one potential operation condition; if the at least one potential factor comprises the at least one potential element of user data of the user profile and if the at least one actual element of user data of the user profile is received, executing one or more fourth computer instructions configured to match the at least one actual element of user data of the user profile with one or more of the at least one potential element of user data of the user profile; if the at least one potential factor comprises the at least one potential user input and if the at least one actual user input is received, executing one or more fifth computer instructions configured to match the at least one actual user input with one or more of the at least one potential user input; if the one or more third computer instructions are executed, executing one or more sixth computer instructions configured to compile a first information group, the first information group comprising each unit of marketing information of the at least one unit of marketing information that is indexed according to the at least one selection category that relates to the at least one potential operating condition comprising the one or more of the at least one potential operation condition; if the one or more fourth computer instructions are executed, executing one or more seventh computer instructions configured to compile a second information group, the second information group comprising each unit of marketing information of the at least one unit of marketing information that is indexed according to the at least one selection category that relates to the at least one potential operating condition comprising the one or more of the at least one potential user input; if the one or more fifth computer instructions are executed, executing one or more eighth computer instructions configured to compile a third information group, the third information group comprising each unit of marketing information of the at least one unit of marketing information that is indexed according to the at least one selection category that relates to the at least one potential operating condition comprising the one or more of the at least one potential user input; and executing one or more ninth computer instructions configured to combine at least one of the first information group, the second information group, or the third information group into a fourth information group, wherein the relevant information comprises the fourth information group.

Further embodiments include a method. The method can be implemented via execution of computer instructions configured to run at one or more processing modules and configured to be stored at one or more non-transitory memory storage modules. The method can comprise: executing one or more first computer instructions configured to receive at least one user input from at least one of a user of an electric vehicle charging station, a user database, or an electric vehicle, the at least one user input comprising a desired level of charge and an existing level of charge; executing one or more second computer instructions configured to receive first data and second data, wherein the second data comprises marketing information; executing one or more third computer instructions configured to determine at least a portion of the second data that is relevant to at least one of the user or the electric vehicle; and executing one or more fourth computer instructions configured to provide the at least the portion of the second data to the user. Further, executing the one or more third computer instructions can comprise: executing one or more fifth computer instructions configured to calculate an approximate quantity of time remaining to provide the desired level of charge; and executing one or more sixth computer instructions configured to compile the at least the portion of the second data based on the approximate quantity of time remaining to provide the desired level of charge from the existing level of charge.

Various embodiments include a system. The system comprises a communications module, an operations module, and an output module. The communications module can be configured to receive (a) at least one user input from at least one of a user of an electric vehicle charging station, a user database, or an electric vehicle, where the at least one user input comprises a desired level of charge and an existing level of charge, (b) first data, and (c) second data, where the second data comprises marketing information. Further, the operations module can be configured to communicate with the communications module and to determine at least a portion of the second data that is relevant to at least one of the user or the electric vehicle. Further still, the output module can be configured to communicate with the communications module and the operations module and to provide to the user the at least the portion of the second data. Also, the operations module can be configured to (a) calculate an approximate quantity of time remaining to provide the desired level of charge, and (b) compile the at least the portion of the second data based on the approximate quantity of time remaining to provide the desired level of charge from the existing level of charge.

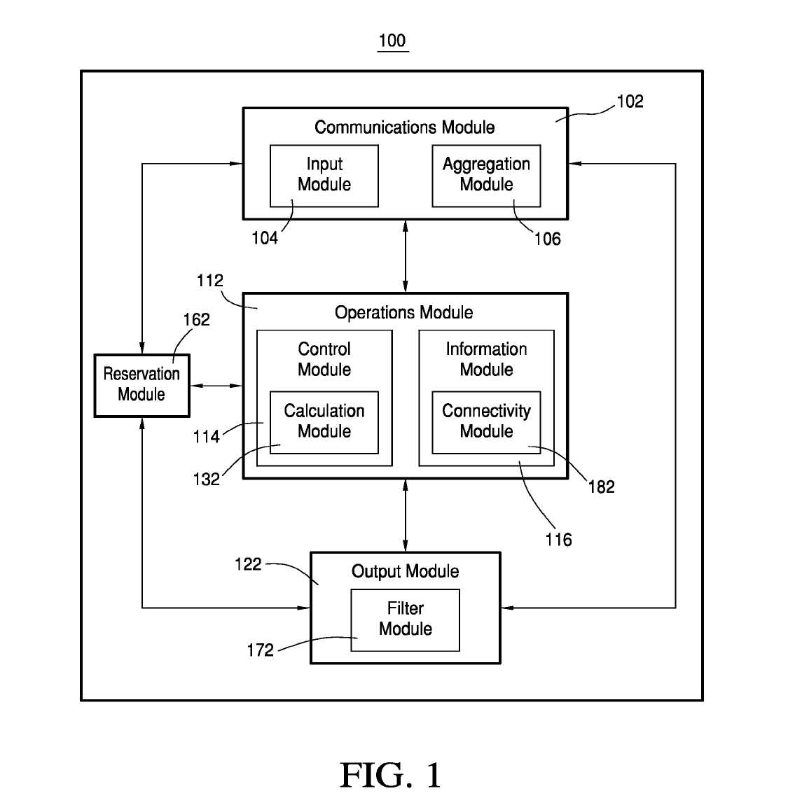

Turning to the figures, FIG. 1 illustrates a block diagram of a system 100 configured to communicate with a user of an electric vehicle charging station, according to an embodiment of system 100. System 100 can be configured to be run on one or more processors of a computer system and storable in one or more memory units of the computer system. In the same or different embodiments, the computer system can be similar to computer system 200 as described in further detail below. In the same or different embodiments, the computer system can be similar to computer system 200 as described in further detail below. System 100 is merely exemplary and is not limited to the embodiments presented herein. System 100 can be employed in many different embodiments or examples not specifically depicted or described herein.

In many embodiments, any single module/sub-module or combination of modules/sub-modules of system 100 can comprise hardware and/or software. In the same or different embodiments, where any single module/sub-module or combination of modules/sub-modules of system 100 comprises hardware and/or software, that module or those modules of system 100 can further be combined with an additional module/sub-module or multiple modules/sub-modules of hardware and/or software of a system other than system 100.

In many embodiments, any single module/sub-module or combination of modules/sub-modules of system 100 can be configured to communicate with any other single module/sub-module or combination of modules/sub-modules of system 100. In the same or different embodiments, where any single module/sub-module or combination of modules/sub-modules of system 100 is configured to communicate with any other single module/sub-module or combination of modules/sub-modules of system 100, communication can comprise a passing of information between the any single module/sub-module or combination of modules/sub-modules of system 100 and the any other single module/sub-module or combination of modules/sub-modules of system 100.

In many embodiments, system 100 can be configured to operate in real time. In the same or different embodiments, at least one module and/or sub-module in system 100 can be configured to perform an operation upon the occurrence of another operation by at least one of or a combination of the other modules of system 100. In the same or different embodiments, at least one module and/or sub-module in system 100 can be configured to perform an operation upon the occurrence of an operation by a combination of the other modules of system 100 when the other modules operate in a specified sequence. In still other embodiments, at least one module and/or sub-module in system 100 can be configured to operate upon the passage of a certain interval of time.

In some embodiments, system 100 can comprise a public system. In many embodiments, where system 100 comprises a public system, system 100 can comprise at least one of a government public system or a commercial public system (including a non-profit public system). In some embodiments, where system 100 comprises a public system, system 100 can be operated for free or for a fee. In other embodiments, system 100 can comprise a private system. In many embodiments, where system 100 comprises a private system, system 100 can comprise at least one of a domestic private system or a commercial private system (including a non-profit private system). In various embodiments, where system 100 comprises at least one of a domestic private system or a commercial private system, system 100 can be privately leased or owned.

Referring back to FIG. 1, system 100 comprises communications module 102 configured to be run on the one or more processors. Communications module 102 is configured to receive first data and at least one input. In some embodiments, communications module 102 can comprise input module 104. Input module 104 can be configured to receive the at least one input. The at least one input comprises at least one of at least one user input from the user, at least one database input, or at least one vehicle input. In some embodiments, communications module 102 and/or input module 104 can be configured to receive one or more coupons (e.g., charging coupons and/or coupons for third-party products/services) from the user. In further embodiments, communications module 102 can further comprise aggregation module 106. Aggregation module 106 can be configured to receive the first data. The first data can comprise marketing information.

In some embodiments, when communications module 102 receives the at least one user input, system 100 comprises at least one of a touch screen display, a keyboard, a keypad, a voice recognition device, a magnetic card reading device, a barcode reading device, an optical recognition device, at least one wireless networking device (including a radio frequency identification (RFID) device), or a wired networking device, that the user uses to provide the at least one user input. In other embodiments, when communications module 102 receives the at least one user input, system 100 comprises at least one network connection that the user uses to provide the at least one user input via the at least one wireless networking device and/or the wired networking device. In further embodiments, when communications module 102 receives the at least one database input, system 100 further comprises at least one computer database that provides the at least one database input. The at least one computer database can be stored locally in at least one of the one or more memory units of the computer system of system 100 and/or communications module 102. In a different embodiment, the at least one computer database can be stored remotely in at least one of one or more other memory units of one or more other computer systems of (a) system 100 and/or (b) a third-party that are in electrical communication with communications module 102 by (i) the at least one network connection (e.g., the network connection providing the at least one user input) or (ii) at least one other network connection. In some embodiments, when communications module 102 receives the at least one vehicle input, communications module 102 comprises (a) at least one of at least one wireless networking device to receive the at least one vehicle input wirelessly from an electric vehicle or (b) at least one wired communication line to receive the at least one vehicle input in a wired manner from the electric vehicle.

In some embodiments, when system 100 comprises the at least one computer database, the computer database(s) can be configured to receive, aggregate, compile, and store the at least one input for user profile(s) for the user(s). In the same or different embodiments, the computer database can use information stored in the user profile for future transactions to provide the at least one database input. In some embodiments, the user profile can be a profile directly established by the user(s) (i.e., created and subject to modification by the user(s)) and/or indirectly established by a provider of system 100 (i.e., where the provider stores data relating to the client for the provider's purposes only). In many embodiments, the computer database(s) can provide the at least one database input automatically from the user profile upon receiving an authentication from the user (e.g., a pass code, an identifying signal, etc.) that validates the identity of the user and/or indicates which user profile from which to provide the at least one database input.

In other embodiments, when system 100 comprises at least one wireless networking device, the wireless networking device can comprise at least one of a radio frequency communication device, a microwave communication device, or an infrared communication device. In various embodiments, system 100 can comprise at least one antenna. In some embodiments, when system 100 comprises at least one wireless networking device, the wireless networking device can be configured to communicate via the at least one antenna. In various embodiments, when system 100 comprises at least one wireless networking device, the wireless networking device can be configured to communicate via at least one photodiode receiver configured to convert infrared radiation to an electric signal. In some embodiments, when system 100 comprises at least one wireless networking device, the wireless networking device can be configured to communicate via terrestrial communications or space-based communications. In still other embodiments, when system 100 comprises at least one wireless networking device, the at least one wireless networking device can be configured to communicate via at least one cellular telephone network. In the same or different embodiments, the at least one cellular telephone network can comprise at least one of a code division multiple access (CDMA) (e.g., IS-95) network, a global system for mobile communications (GSM) network, a time division multiple access (TDMA) network, and/or an orthogonal frequency-division multiplexing (OFDM) network, and the like. In some embodiments, the CDMA and/or GSM networks can be configured to operate in 2G, 3G, and/or 4G (e.g., implementing multiple OFDM networks operating with multi-carrier code division multiple access (MC-CDMA) and multiple-input and multiple-output (MIMO) configurations) modalities, and the like. In many embodiments, when system 100 comprises at least one wireless networking device, the wireless networking device can be configured to communicate via radio frequency identification (RFID) transmission. For example, in some embodiments, the wireless networking device can comprise an interrogator device configured to read an RFID tag provided by the at least one user.

In many embodiments, when system 100 comprises the at least one network connection, the at least one network connection can comprise one or more wireless and/or wired network connections. The at least one network connection can comprise at least one of a worldwide network, a local area network, a wide area network, a metropolitan area network, or a personal area network. In many embodiments, when the at least one network connection comprises one or more wireless network connections, the one or more wireless network connections can operate with one or more frequencies (e.g., 802.11(a), (b), (g), (n)). In some embodiments, when the at least one network connection comprises one or more wireless network connections, the one or more wireless network connections can operate via a mesh network or radial/star network. Examples of a mesh network include Bluetooth™ and ZigBee® wireless protocols. Examples of a radial network include the 802.11 wireless protocol. In various embodiments, when system 100 comprises at least one wired and/or wireless networking device and the at least one network connection, the at least one wired and/or wireless networking device (e.g., a modem and/or router) can be configured to communicate via the at least one network connection.

Communications module 102 is configured to receive the first data from at least one of: (a) the one or more memory units of the computer system of system 100 or (b) at least one network connection. The at least one network connection can provide the first data from one or more computer databases stored at one or more memory units of one or more other computer systems. In the same or different embodiments, the one or more computer systems can be similar to computer system 200 as described in further detail below. The at least one network connection can comprise and/or can be configured similarly to the at least one network connection described above with respect to the at least one input. For example, in some embodiments, communications module 102 can be configured to receive any input of the at least one input and/or the first data via the same network connection. In other embodiments, system 100 and/or connection module 102 can comprise multiple network connections configured to receive any of the one or more inputs of the at least one input and/or the first data. The one or more other computer systems can be part of system 100 and/or can be separate from system 100 (e.g., operated by a third-party).

In some embodiments, the at least one user input from the user can be provided by multiple users. The user(s) can comprise at least one of a driver, a passenger, and/or an owner of a vehicle. In the same or different embodiments, the at least one vehicle input can be provided by one or more vehicle(s) of the user. In the same or different embodiments, the one or more vehicle(s) can comprise at least one of a car, a truck, a motorcycle, a bicycle, a scooter, a boat, a train, an aircraft, an airport ground support equipment, a material handling equipment (e.g., a fork-lift), etc. In many embodiments, the vehicle(s) can comprise an electric vehicle and/or a plug-in hybrid electric vehicle.

In many embodiments, at least one of the at least one user input or the at least one database input comprises at least one of a make of the vehicle, a model of the vehicle, a manufacturing year of the vehicle, a type of a rechargeable energy storage system of the vehicle, a type and/or size of at least one battery for the rechargeable energy storage system, a history of use of the rechargeable energy storage system, at least one user preference, at least one response of the user, at least one user inquiry of the user, an amount of time the user is willing to wait to receive a desired level of charge for the rechargeable energy storage system, a time at which the user requires the vehicle for use, a maximum price per unit of energy that the user is willing to pay, a maximum price that the user is willing to pay for charging the vehicle, a reservation for at least one interval of time during which to use the electric vehicle charging station, a reservation for at least one interval of time during which to use an alternative electric vehicle charging station, an odometer reading of the vehicle, a request that the electric vehicle charging station provide electricity from an alternative energy source, feedback on using the electric vehicle charging station, a desired level to which to charge the rechargeable energy storage system, a desired level to which to charge the at least one battery, at least one interest of the user, a telephone number of the user, or an email address of the user. In the same or different embodiments, the at least one user and/or database input can further comprise a request to book a temporary property, such as a motel or hotel room. In the same or different embodiments, the alternative energy source can be wind, nuclear, hydroelectric, tidal, and/or solar generated energy.

In the same or different embodiments, at least one of the at least one vehicle input or the at least one database input comprises at least one of the make of the vehicle, the model of the electric vehicle, the manufacturing year of the electric vehicle, the type of the rechargeable energy storage system of the vehicle, the type and/or size of the battery for the rechargeable energy storage system, the history of use of the rechargeable energy storage system, the odometer reading of the vehicle, a total capacity of charge for the rechargeable energy storage system, or a total capacity of charge of a battery for the rechargeable energy storage system, a state of charge of the rechargeable energy storage system; a temperature of the rechargeable energy storage system (e.g., a temperature of all of the rechargeable energy storage system and/or one or more subsections or modules of the rechargeable energy storage system), or an electric voltage of the rechargeable energy storage system (e.g., an electric voltage of all of the rechargeable energy storage system and/or one or more subsections or modules of the rechargeable energy storage system). Other user and/or database inputs described earlier could also be vehicle inputs. In some embodiments, the at least one of the at least one vehicle input or the at least one database input further comprises the desired level to which to charge the rechargeable energy storage system. In the same or different embodiments, at least one of the at least one user input or the at least one vehicle input can comprise an existing level of charge of the rechargeable energy storage system and/or the at least one battery.

The rechargeable energy storage system can comprise a device configured to store electricity for the vehicle(s). In many embodiments, the rechargeable energy storage system can comprise (a) one or more batteries and/or one or more fuel cells, (b) one or more super capacitors (e.g., electric double-layer capacitor), and/or (c) one or more electric flywheels. In many embodiments, the one or more batteries can comprise one or more rechargeable (e.g., traction) and/or non-rechargeable batteries. For example, the one or more batteries can comprise one or more of a lead-acid battery, a valve regulated lead acid (VRLA) battery, a gel battery, an absorbed glass mat (AGM) battery, a nickel-cadmium (NiCd) battery, a nickel-zinc (NiZn) battery, a nickel metal hydride (NiMH) battery, a zebra (e.g., molten chloroaluminate (NaAlCl₄)) and/or a lithium (e.g., lithium-ion (Li-ion)) battery. In some embodiments, where the rechargeable energy storage system comprises more than one battery, the batteries can all comprise the same type of battery. In other embodiments, where the rechargeable energy storage system comprises more than one battery, the batteries can comprise at least two types of batteries. In many embodiments, the at least one fuel cell can comprise at least one hydrogen fuel cell.

In many embodiments, the marketing information can be: (a) stored in the one or more memory units of the computer system of system 100; and/or (b) received by system 100, and can comprise one or more advertisements, food menus, movie information and/or times, sporting event information and/or times, and/or coupons. In the same or different embodiments, system 100 and/or output module 122, as described in greater detail below, can comprise a printer configured to provide the one or more advertisements, food menus, movie information and/or times, sporting event information and/or times, and/or coupons. In the same or different embodiments, the printer can be configured to provide at least one ticket for at least one of a movie having the movie time or a sporting event having the sporting event time. In the same or different embodiments, the user can make a reservation at a restaurant corresponding to the food menu(s) via communications module 102, as described above.

For example, in the same or different embodiments, the advertisement(s) can comprise advertisement(s) for a business located close to the electric vehicle charging station. In the same or different embodiments, the food menu(s) can comprise food menu(s) for one or more restaurant located close to the electric vehicle charging station. In the same or different embodiments, the movie time can comprise at least one movie time for a movie at a movie theater located close to the electric vehicle charging station. In the same or different embodiments, the sporting event time can comprise at least one sporting event time for a sporting event at a sporting event venue located close to the electric vehicle charging station. In the same or different embodiments, the coupon can comprise at least one coupon for a product of a business (e.g., a grocery store) located close to the electric vehicle charging station. In the same or different embodiments, being located close to the electric vehicle charging station can comprise a distance that is at least one of easy, comfortable, or manageable to walk by an average person or that is convenient for a short taxi ride (e.g., a distance less than approximately one, two, five, or ten miles (less than approximately 1.6, 3.2, 8.0, or 16.0 kilometers)).

In other examples, the advertisement(s) can comprise advertisement(s) for a business that is not located close to the electric vehicle charging station. In the same or different embodiments, the food menu(s) can comprise food menu(s) for one or more restaurant that is not located close to the electric vehicle charging station. In the same or different embodiments, the movie time can comprise at least one movie time for a movie at a movie theater that is not located close to the electric vehicle charging station. In the same or different embodiments, the sporting event time can comprise at least one sporting event time for a sporting event at a sporting event venue that is not located close to the electric vehicle charging station. In the same or different embodiments, the coupon can comprise at least one coupon for a product of a business (e.g., a grocery store) that is not located close to the electric vehicle charging station. In the same or different embodiments, not being located close to the electric vehicle charging station can comprise a distance that is not easy, comfortable, and/or manageable to walk by the average person or that is not convenient for a short taxi ride (e.g., a distance more than approximately one, two, five, or ten miles (more than approximately 1.6, 3.2, 8.0, or 16.0 kilometers)).

In some embodiments, the first data further comprises at least one of a governmental message, a news message, a political message, or a public service announcement. In further embodiments, the public service announcement can comprise amber alerts, weather information, weather warnings, road conditions, security warnings, and/or traffic conditions.

In some embodiments, communications module 102 can be further configured to receive operating information comprising at least one of days and times during which the electric vehicle charging station is available, days and times during which the electric vehicle charging station is reserved, locations of other electric vehicle charging stations, a present cost of electricity and/or charging, one or more past costs of electricity and/or charging for at least one past time and date, one or more predictions (i.e., estimates) of future costs of electricity and/or charging for at least one future time and date, a current load on an electric grid to which the electric vehicle charging station is coupled, past loads on the electric grid for the at least one past time and date, predictions (i.e., estimates) of future loads on the electric grid for the at least one future time and date, or an amount of available electricity from the electric grid.

In various embodiments, communications module 102 can be configured to automatically refresh the first data and/or the operating information in real time such that operations module 112, as described below, regularly receives the refreshed first data and/or operating information to maximize the accuracy and/or relevancy of the first data and/or operating information.

Referring back to FIG. 1, system 100 comprises operations module 112 configured to be run on the one or more processors. Operations module 112 is configured to receive the first data and the at least one input from communications module 102, to control the electric vehicle charging station according to operating conditions established by at least the at least one input, and to select at least a portion of the first data to provide to the user based on the at least one user input, the operating conditions, and/or a geographic location of the electric vehicle charging station. In some embodiments, operations module 112 can comprise control module 114. Control module 114 can be configure to control the electric vehicle charging station according to the operating conditions established by the at least the at least one input. In further embodiments, system 100 and/or operations module 112 can comprise information module 116. In the same or different embodiments, information module 116 can be configured to select the at least the portion of the first data to provide to the user based on the at least one user input, the operating conditions, and/or a geographic location of the electric vehicle charging station, for operations module 112. In some embodiments, system 100 can comprise a parking meter, a light pole, and/or a public telephone system. In the same or different embodiments, operations module 112 can be configured to operate the parking meter and/or the public telephone system.

In various embodiments, the operating conditions comprise at least one of at least one time at which the electric vehicle charging station is coupled with and/or charging an electric vehicle or at least one length of at least one interval of time during which the electric vehicle charging station is coupled with and/or charging the electric vehicle. In many embodiments, the operating conditions of the electric vehicle charging station are further established by the operating information received by communications module 102. Referring back to FIG. 1, in some embodiments, system 100, operations module 112, and/or control module 114 can comprise calculation module 132. In many embodiments, calculation module 132 can be configured to iteratively perform calculations to derive and/or update one or more of the operating conditions for the electric vehicle charging station. For example, calculation module 132 can be configured to continuously or periodically recalculate the amount of time required to provide a charge to the rechargeable energy storage system during the course of charging the rechargeable energy storage system.

In various embodiments, when operations module 112 selects the at least the portion of the first data to provide to the user based on the at least one user input, the at least one user input comprises at least one user preference (e.g., interest) and the at least the portion of the first data comprises a portion of the marketing information and/or other first data that is relevant to the at least one user preference. For example, when the at least one user input comprises a user preference for Italian food or for romance movies, etc., the portion of the first data can comprise a portion of the marketing data relating to the preference provided.

In various embodiments, when operations module 112 selects the at least the portion of the first data to provide to the user based on the at least one user input, the at least one user input comprises the make, model, and/or year of the vehicle, the odometer reading of the vehicle, and/or maintenance codes for the vehicle, and the at least the portion of the first data comprises a portion of the marketing information and/or other first data relating to various car maintenance activities (e.g., oil changes, tune-ups, etc.) that are applicable to the at least one vehicle. Combined with a configuration in which operations module 102 provides the at least the portion of the first data based on geographic location, the portion of the first data can comprise a portion of the first data pertaining to a local car mechanic to provide one or more of the previously identified services or the like.

In further embodiments, when operations module 112 selects the at least the portion of the first data to provide to the user based on the operating conditions, the operating conditions comprise at least one time at which the electric vehicle charging station is coupled with and/or charging an electric vehicle and the at least the portion of the first data comprises a portion of the marketing information and/or other first data that is relevant to the at least one time at which the electric vehicle charging station is coupled with and/or charging the electric vehicle. For example, when the at least one time is a meal time, the portion of the marketing information can comprise advertisements and/or food menus for restaurants. For the same exemplary time condition, the marketing information can comprise advertisements and/or coupons for grocery stores and the like.

In some embodiments, when operations module 112 selects the at least the portion of the first data to provide to the user based on the operating conditions, the operating conditions comprise at least one length of at least one interval of time during which the electric vehicle charging station is coupled with and/or charging an electric vehicle the at least the portion of the first data comprises a portion of the marketing information and/or other first data that is relevant to the at least one length of the at least one interval of time during which the electric vehicle charging station is coupled with and/or charging the electric vehicle. For example, when the at least one length of the at least one interval of time is sufficiently long, the portion of the marketing information can comprise movie information and/or times that fall within and/or span the length of the interval of time. In further examples, the portion of the marketing information can comprise sporting events and/or entertainment events, etc.

In still other embodiments, when operations module 112 selects the at least the portion of the first data to provide to the user based on the geographic location of the electric vehicle charging station, the at least the portion of the first data comprises a portion of the marketing information and/or other first data that is relevant to a geographic area comprising the geographic location. For example, the portion of the marketing information can comprise any of the exemplary marketing information described above that relates to businesses and/or venues located close to the electric vehicle charging station. If the charging station is located close to a shopping mall, the portion of the marketing information could comprise marketing information on stores and restaurants located in or around the shopping mall. In other examples, the electric vehicle charging station could be located close to an entertainment venue, a grocery store, a strip mall, a gas station, etc., any of which that the portion of the marketing information could correspond. In still other examples, the portion of the marketing information can comprise marketing information relating to (a) communities located close to the electric vehicle charging station or (b) municipalities (i) in which the electric vehicle charging station is located or (ii) close to which the electric vehicle charging station is located.

In many embodiments, the electric vehicle charging station can be configured to operate as part of a charging network. In the same or different embodiments, the charging network can comprise multiple electric vehicle charging stations. In the same or different embodiments, each electric vehicle charging station can be configured to communicate with any of the other electric vehicle charging stations of the charging network, or each electric vehicle charging station can be isolated from and not in communication with the other electric vehicle charging stations of the charging network. In many embodiments, users can become members of the charging network. In some embodiments, when users become members, the user(s) can establish user profiles, as described above, to streamline the charging process and/or to enable operations module 112 to better tailor to the user the selection of the at least the portion of the first data to provide to the user. In the same or different embodiments, users can become members of the network by providing a one-time and/or a recurring fee or in some examples, at no cost.

In many embodiments, the electric vehicle charging station can comprise an electric vehicle supply equipment (e.g., a device for providing electricity to the rechargeable energy storage system of the electric vehicle), and the electric vehicle supply equipment can comprise an electric vehicle supply equipment board. In other embodiments, the electric vehicle charging station can comprise an industrial electric charger (e.g., an on-board AC electric charger, a off-board DC electric charger). In still other embodiments, the electric vehicle charging station can be configured to transfer electricity to a rechargeable energy storage system of the at least one electric vehicle via electrical induction. The electric vehicle charging station can comprise either of a stand-alone unit or a wall-mounted unit.

In various embodiments, the electric vehicle supply equipment can comprise a level 1 electric vehicle supply equipment, a level 2 electric vehicle supply equipment, and/or a level 3 electric vehicle supply equipment. The level 1 electric vehicle supply equipment can comprise either of a level 1 alternating current (AC) electric vehicle supply equipment or a level 1 direct current (DC) electric vehicle supply equipment. Meanwhile, the level 2 electric vehicle supply equipment can comprise either of a level 2 AC electric vehicle supply equipment or a level 2 DC electric vehicle supply equipment. Furthermore, the level 3 electric vehicle supply equipment can comprise either of a level 3 AC electric vehicle supply equipment or a level 3 DC electric vehicle supply equipment. In some embodiments, the level 2 electric vehicle supply equipment and/or the level 3 electric vehicle supply equipment can also be referred to as a fast charger. In many embodiments, the electric vehicle supply equipment can make available electricity comprising a maximum electric current of 30 amperes (A) or 48 A. When the maximum electric current of the electric vehicle supply equipment comprises 30 A, the electric vehicle supply equipment can be configured to make available electricity comprising an electric current of one or more of 12 A, 16 A, or 24 A. When the maximum electric current of the electric vehicle supply equipment comprises 48 A, the electric vehicle supply equipment can be configured to make available electricity comprising an electric current of one or more of 12 A, 16 A, 24 A, or 30 A.

For example, the level 1 AC electric vehicle supply equipment can make available electricity comprising an electric voltage of approximately 120 volts (V) and an electric current: greater than or equal to approximately 0 amperes (A) and less than or equal to approximately 12 A AC, when employing a 15 A breaker, or (b) greater than or equal to approximately 0 A and less than or equal to approximately 16 A AC, when employing a 20 A breaker. Accordingly, the level 1 electric vehicle supply equipment can comprise a standard grounded domestic electrical outlet. Meanwhile, the level 2 AC electric vehicle supply equipment can make available electricity comprising an electric voltage greater than or equal to approximately 208 V and less than or equal to approximately 240 V and an electric current greater than or equal to approximately 0 A and less than or equal to approximately 80 A AC. Furthermore, a level 3 electric vehicle supply equipment can make available electricity comprising an electric voltage greater than or equal to approximately 208 V and an electric current greater than or equal to approximately 80 A AC (e.g., 240 V AC (single phase), 208 V AC (triple phase), 480 V AC (triple phase). In some embodiments, the electric voltages for the level 1 electric vehicle supply equipment, the level 2 electric vehicle supply equipment, and/or the level 3 electric vehicle supply equipment can be within plus or minus (±) ten percent (%) tolerances of the electric voltages provided above.

In other examples, the level 1 DC electric vehicle supply equipment can provide electric power greater than or equal to approximately 0 kiloWatts (kW) and less than or equal to approximately 19 kW. Meanwhile, the level 2 DC electric vehicle supply equipment can provide electric power greater than or equal to approximately 19 kW and less than or equal to approximately 90 kW. Furthermore, level 3 electric vehicle supply equipment can provide electric power greater than or equal to approximately 90 kW. In some embodiments, the term fast charger can refer to an electric vehicle supply equipment providing electricity comprising an electric voltage between approximately 300 V-500 V and an electric current between approximately 100 A-400 A DC.

The industrial electric charger (e.g., the on-board AC electric charger, the off-board DC electric charger) can provide electric power greater than or equal to approximately 3 kW and less than or equal to approximately 33 kW. The off-board DC electric charger can provide electricity comprising an electric voltage greater than or equal to approximately 18 V DC and less than or equal to approximately 120 V DC.

In many embodiments, the electric vehicle charging station can comprise at least one electrical connector each being coupled to the electric vehicle charging station via an electric cable. In many embodiments, the electrical connector(s) can comprise a J1772 standard electrical connector. In other embodiments, the electrical connector(s) can comprise an IEC 62196 electrical connector. In various embodiments, the electrical connector(s) can comprise a JARI Level 3 DC electrical connector. In many embodiments, the electric cable can be one of approximately 10, 12, 14, 16, 18, or 20 feet (3.1, 3.7, 4.3, 4.9, 5.5, or 6.1 meters) in length. Where the charging station has more than one electrical connector, the electric vehicle charging station can provide and/or receive electricity to and/or from multiple vehicles simultaneously and/or a second vehicle via a second electrical connector while a first vehicle is coupled to a first electrical connector but is not currently receiving a charge therefrom.

In further embodiments, the electric vehicle charging station can comprise a rechargeable energy storage system exchange station. In still further embodiments, the electric vehicle charging station can be configured for wireless energy transfer (e.g., charging). Wireless energy transfer can comprise inductive, microwave, or other non-conductive forms of energy transfer. In various embodiments, the electric vehicle charging station can comprise a gaseous or liquid fuel dispensing system.

In some embodiments, the electric vehicle charging station can be coupled to an electrical grid and receive electricity from a remote location. In other embodiments, the electric vehicle charging station can generate electricity at and/or near the electric vehicle charging station using at least one of solar energy generation, wind energy generation (e.g., turbines), tidal energy generation, or hydroelectric energy generation.

In many embodiments, the electric vehicle charging station can be configured to comply with the International Organization for Standardization (ISO) standards for safety (e.g., ISO 6469). In various embodiments, the electric vehicle charging station can comprise an automatic shutoff feature for emergencies. In further embodiments, the electric vehicle charging station can incorporate insulating materials to prevent contact with electrically conductive components of the electric vehicle charging station.

In some embodiments, the electric vehicle charging station can comprise an electricity meter. In the same or different embodiments, the electricity meter can be configured to measure the amount of energy transferred: (a) from the electric vehicle charging station to the rechargeable energy storage system of the vehicle; or (b) to the electric vehicle charging stations from the rechargeable energy storage system of the vehicle. In the same or different embodiments, the electricity meter can be a part of and configured to communicate with the electric vehicle charging station. In other embodiments, the electricity meter can be separate from the electric vehicle charging station and configured to communicate with the electric vehicle charging station. In the same or different embodiments, the electricity meter can comprise a certified energy and demand meter. In the same or different embodiments, the electricity meter can be configured to perform revenue grade electricity metering. In the same or different embodiments, the electricity meter can comprise an electronic electricity meter. In other embodiments, the electricity meter can comprise an electromechanical electricity meter. In many embodiments, the electricity meter can comprise a smart electricity meter. In various embodiments, the electricity meter can comprise a self-contained electricity meter.

In many embodiments, the electric vehicle charging station can comprise a locking mechanism. In some embodiments, the locking mechanism can prevent the electrical connector(s) from being disconnected from vehicles while transferring electricity to/from the vehicle(s). For example, in many embodiments, the locking mechanism can prevent a non-paying and/or a non-member user from disconnecting the electrical connector from a first vehicle of a paying and/or member user and connecting the electrical connector to another vehicle to steal a charge from the paying and/or member user. In the same or different embodiments, at least part of the locking mechanism can comprise a mechanical device configured to lock electrical connector(s) to the vehicle(s). In some embodiments, the locking mechanism can comprise a key lock or a combination lock. In the same or different embodiments, the locking mechanism can further comprise electrical components. In many embodiments, the electrical components can permit the locking mechanism to engage and disengage electronically. In many embodiments, the user and/or output module 122, described below, can provide a code that the user can later provide to communication module 102 and/or output module 122 in order to disengage the locking mechanism. In the same or different embodiments, the code can be specific to and/or reusable by the user (e.g., a pin number or the user's RFID tag) or the code can be a randomly generated code.

In the same or different embodiments, the electric vehicle charging station can comprise a termination mechanism. In many embodiments, the termination mechanism can automatically terminate a transfer of electricity in the event that the electrical connector(s) is/are disconnected from the vehicle or that the electric vehicle charging station is tampered with in some specified manner In the same or different embodiments, the termination mechanism can be reset upon a properly received command from the user such that the transfer of electricity can continue. In the same or different embodiments, the termination mechanism can be configured to disengage when under certain conditions. In some embodiments, the termination mechanism can disengage when the user correctly authenticates his/her identity via communications module 102 and/or output module 122. In many embodiments, the user can correctly authenticate himself/herself with a code similar to the code of the locking mechanism. In the same or different embodiments, the termination mechanism can disengage after a specified period of time. In other embodiments, the termination mechanism can disengage when sensing a radio frequency identification signal that is provided by the user. In the same or different embodiments, the radio frequency identification signal can be provided by the vehicle of the user and/or the user's RFID tag.

In many embodiments, the electric vehicle charging station can comprise both the locking mechanism and the termination mechanism. In the same or different embodiments, the charging station can comprise a sensor to detect when the electrical connector(s) has/have been disconnected from the vehicle. In many embodiments, the sensor can be part of the electrical connector(s).

Referring now back to FIG. 1, in many embodiments, system 100, operations module 112, and/or information module 116 can comprise connectivity module 182. In the same or different embodiments, connectivity module 182 can be configured to provide at least one network browser by which the user can access the internet. In the same or different embodiments, connectivity module 182 can be configured to communicate with communications module 102 and/or output module 122. In the same or different embodiments, connectivity module 182 can send and/or receive internet data using the at least one network connection of system 100.

Referring back to FIG. 1, system 100 comprises output module 122 configured to be run on the one or more processors. Output module 122 is configured to receive the at least the portion of the first data from operations module 112 and to provide one or more outputs to the user. The one or more outputs comprise the at least the portion of the first data. In many embodiments, providing the at least the portion of the first data to the user can encourage the placement of the electric vehicle charging station, can defray costs of operating the electric vehicle charging station, and can provide general economic benefits to an operator of the electric vehicle charging station and/or system 100. In many embodiments, output module 122 provides the outputs to the user while at least one of operations module 112 is controlling the electric vehicle charging station or communications module 102 is receiving the at least one input. For locations where laws and/or regulations restrict or forbid commercial advertising in conjunction with certain related applications (e.g., refueling a vehicle, etc.), the outputs can be limited to first data that does not constitute commercial advertisements. In some embodiments, output module 122 can comprise a browsing interface (e.g., a menu) to allow interactive navigation of the outputs. The outputs can be organized and classified for the ease of navigation by the user. The one or more outputs can comprise one or more visual (e.g., images) and/or audible outputs (e.g., sound bytes and/or music). In the same or different embodiments, the one or more visual and/or audible outputs can comprise a variety of visual and/or audible forms, respectively. In some examples, the one or more visual outputs and the one or more audible outputs can be complimentary/unrelated and/or provided simultaneously/separately. In various embodiments, the one or more outputs can be provided to the user sequentially or randomly.

In many embodiments, system 100, communications module 102, operations module 112, and/or output module 122 comprise one or more displays, and output module 122 can be configured to provide the one or more visual outputs via the one or more displays. In various embodiments, the one or more displays can be the same as or different than the at least one touch screen display by which the user provides the at least one user input to communications module 102. In further embodiments, system 100, communications module 102, operations module 112, and/or output module 122 comprises one or more speakers, and output module 122 can be configured to provide the one or more audible outputs via the one or more speakers. In many embodiments, when the one or more displays comprise two or more displays, output module 122 can be configured to provide at least a first portion of the outputs (e.g., outputs relating to the operation of the electric vehicle charging station) on a first display and at least a second portion of the outputs (e.g., the at least the portion of the first data) on a second display. In the same or different embodiments, the first display can be above, below, to the left of, and/or to the right of the second display. In the same or different embodiments, the first display can be any of larger or smaller than or equal to the second display in size. In many embodiments, the first display can comprise a diagonal measurement of greater than or equal to approximately 15 centimeters (5.9 inches) and less than or equal to approximately 44 centimeters (17.4 inches). For example, the first display can comprise a diagonal measurement of approximately 17 centimeters (6.7 inches). In the same or different embodiments, the second display can comprise a diagonal measurement of greater than or equal to approximately 91 centimeters (36 inches) and less than or equal to approximately 117 centimeters (46 inches). For example, the second display can comprise a diagonal measurement of approximately 107 centimeters (42 inches). In an embodiment where the first display is smaller than the second display, the first display can output details and questions regarding the charging process, and the second display can output the advertisements and other marketing information. In some embodiments, the first display can be configured to direct the user to reference the second display, and/or vice versa. In many embodiments, the one or more displays can comprise one or more electronic displays. In many embodiments, the one or more displays can comprise at least one monochrome cathode ray tube display, color cathode ray tube display, direct-view bi-stable storage tube display, flip-flap/disc display, monochrome plasma display, light-emitting diode display, eggcrate display, vacuum fluorescent display, twisted nematic field effect liquid crystal display, pin screen display, thin film transistor liquid crystal display, full-color plasma display, organic light-emitting diode display, electronic paper display, or electroluminescent display. In some embodiments, the one or more displays can be the same and/or different display types.

In the same or different embodiments, output module 122 can be configured to provide the outputs to a mobile device and/or personal computer of the user. In the same or different embodiments, output module 122 can be configured to provide the outputs to the mobile device/personal computer of the user via a telephone call, a short message service (e.g., a text message), and/or e-mail, as applicable.

Referring back to FIG. 1, in some embodiments, output module 122 can comprise filter module 172. Filter module 172 can be configured to manage the way in which the one or more outputs are presented to the user. For example, filter module 172 can split up the one or more outputs between the multiple displays and/or the mobile device/personal computer of the user, where applicable, assign combinations of visual and audible outputs, where applicable, and/or determine what of the one or more outputs to provide the user's mobile device and/or personal computer, etc.

In many embodiments, the one or more outputs can further comprise instructions for operating the electric vehicle charging station. In the same or different embodiments, the instructions can be stored in the one or more memory units of the computer system of system 100 and can be associated with the user's profile. In the same or different embodiments, the one or more outputs can further comprise at least one of at least one option to charge the rechargeable energy storage system of the user's vehicle to a specified level of charge, a power level of a current charge, a predicted cost of providing a requested charge, at least one predicted cost of providing a full charge, at least one actual cost of providing a requested charge, at least one actual cost of providing a full charge, at least one suggested alternative amount of charge, at least one predicted amount of time to provide a requested charge, at least one predicted amount of time to provide a full charge, at least one actual amount of time to provide a requested charge, at least one predicted amount of time to provide a full charge, at least one actual amount of time to provide a full charge, at least one suggested time to begin a charge, at least one suggested time to complete a charge, at least one option to switch reservation times with another user and a potential cost in savings by so doing, at least one option to buy a reserved time from another user, at least one option to sell electricity to the electric vehicle charging station, at least one value of a payment to the user for selling the electricity to the electric vehicle charging station, an option to use alternative energy for the charge, information on the current status of the charge of the rechargeable energy storage system of the user's vehicle, information about a charging network comprising the electric vehicle charging station of system 100 and one or more other charging stations, or information on becoming a member of the charging network. In the same or different embodiments, outputs can further comprise at least one of various locations where the user can charge the user's vehicle, where the locations can be provided by at least distance, zip code, geographic location, area code, a geographical route of travel, a geographical destination, or cost of electricity at the locations. In the same or different embodiments, the locations can be provided at least in a list or on a map. In the same or different embodiments, outputs can further comprise at least one of a notification that the charge has been completed or a notification that the charge has been prematurely ended.

Referring back to FIG. 1, in some embodiments, the at least one user input comprises at least one user input received locally at output module 122 or remotely from a remote database via a computer network connection, remotely from a mobile device (e.g., a smart mobile telephone, etc.) via a cellular telephone network, and/or remotely from a personal computer of the user via a computer network connection. In the same or different embodiments, the at least one database input comprises at least one database input received remotely via the network connection. In the same or different embodiments, the at least one vehicle input comprises at least one vehicle input received locally at output module 122. In some embodiments, when the at least one user input comprises at least one user input received locally at output module 122, the user(s) can provide the user input(s) from a computer system of the vehicle of the user(s). The computer system of the vehicle can be configured to communicate with output module 122. In the same or different embodiments, when the at least one user input comprises at least one user input received locally at output module 122, the user(s) can provide the user input(s) from a user interface of the electric vehicle charging station that comprises output module 122. In still other embodiments, the at least one user input comprises at least one user input received locally at output module 122 from the user's mobile device via the cellular telephone network such as where the user is present at the location of output module 122 but communicates with output module 122 with the mobile device. In many embodiments, the electric vehicle charging station comprises communications module 102, operations module 112, and output module 122. In the same or different embodiments, the electric vehicle charging station can comprise the user interface, and one or more of communications module 102, operations module 112, and output module 122 also can be part of the user interface. In further embodiments, the electric vehicle charging station, the user interface, and/or communications module 102 can comprise a data cable configured to communicate with the vehicle of the user such that the data cable provides a connection by which to receive the at least one vehicle input.

Referring back to FIG. 1, in various embodiments, system 100 can comprise reservation module 162 configured to be run on the one or more processors. In the same or different embodiments, reservation module 162 can be configured to provide a reservation system for the electric vehicle charging station. In many embodiments, the reservation system can comprise a system by which the user can reserve at least one time on a particular day to use the electric vehicle charging station. In the same or different embodiments, the reservation system can further be configured to permit at least one user to reserve at least one time on a particular day to use one or more other electric vehicle charging stations of a charging station network.

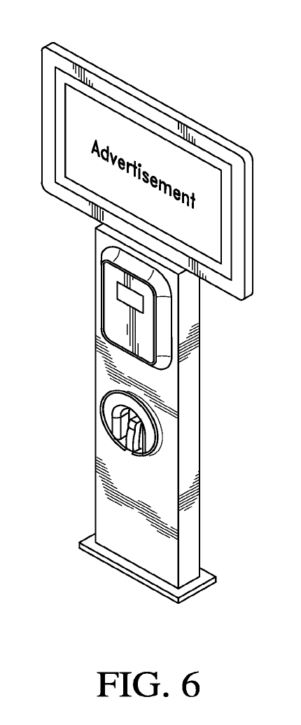

Skipping ahead in the figures, FIG. 6 illustrates an exemplary electric vehicle charging station operating an embodiment of system 100 to communicate an advertisement to one or more user(s).

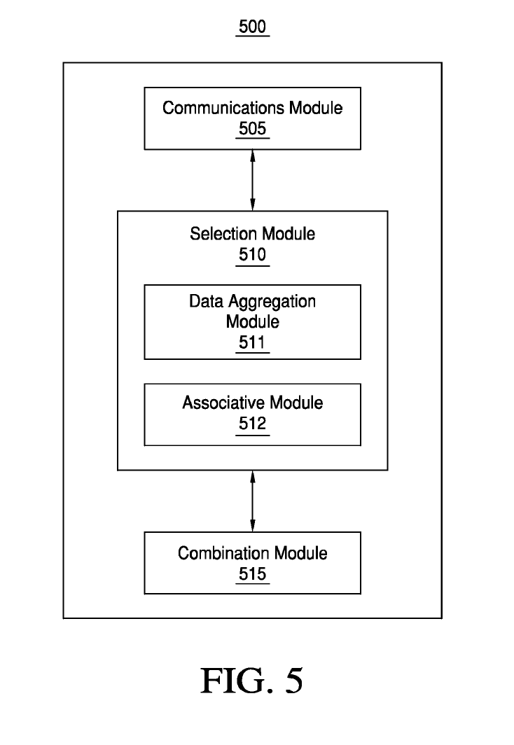

Referring now back to the figures, FIG. 5 illustrates a block diagram of a system 500 for providing relevant information from a set of information, according to an embodiment of system 500. System 500 can be configured to be run on one or more processors of a first computer system and storable in one or more first memory units of the first computer system. In the same or different embodiments, the first computer system can be similar to computer system 200 as described in further detail below. System 500 is merely exemplary and is not limited to the embodiments presented herein. System 500 can be employed in many different embodiments or examples not specifically depicted or described herein.

In many embodiments, any single module/sub-module or combination of modules/sub-modules of system 500 can comprise hardware and/or software. In the same or different embodiments, where any single module/sub-module or combination of modules/sub-modules of system 500 comprises hardware and/or software, that module or those modules of system 500 can further be combined with an additional module/sub-module or multiple modules/sub-modules of hardware and/or software of a system other than system 500.

In many embodiments, any single module/sub-module or combination of modules/sub-modules of system 500 can be configured to communicate with any other single module/sub-module or combination of modules/sub-modules of system 500. In the same or different embodiments, where any single module/sub-module or combination of modules/sub-modules of system 500 is configured to communicate with any other single module/sub-module or combination of modules/sub-modules of system 500, communication can comprise a passing of information between the any single module/sub-module or combination of modules/sub-modules of system 500 and the any other single module/sub-module or combination of modules/sub-modules of system 500.

In many embodiments, system 500 can be configured to operate in real time. In the same or different embodiments, at least one module and/or sub-module in system 500 can be configured to perform an operation upon the occurrence of an operation by at least one of or a combination of the other modules of system 500. In the same or different embodiments, at least one module and/or sub-module in system 500 can be configured to perform an operation upon the occurrence of another operation by a combination of the other modules of system 500 when the other modules operate in a specified sequence. In still other embodiments, at least one module and/or sub-module in system 500 can be configured to operate upon the passage of a certain interval of time.

In some embodiments, system 500 can comprise a public system. In many embodiments, where system 500 comprises a public system, system 500 can comprise at least one of a government public system or a commercial public system (including a non-profit public system). In some embodiments, where system 500 comprises a public system, system 500 can be operated for free or for a fee. In other embodiments, system 500 can comprise a private system. In many embodiments, where system 500 comprises a private system, system 500 can comprise at least one of a domestic private system or a commercial private system (including a non-profit private system). In various embodiments, where system 500 comprises at least one of a domestic private system or a commercial private system, system 500 can be privately leased or owned.

Referring to FIG. 5, system 500 comprises communication module 505 configured to run on the one or more processors. Communication module 505 is configured to receive the set of information from at least one computer database located on at least one of: (a) the one or more first memory units of the first computer system or (b) one or more second memory units of at least one computer system other than the first computer system. In many embodiments, the set of information can be similar to the first data described above with respect to system 100. For example, the set of information can comprise at least one unit of marketing information. As used herein, the term “unit” is generally to be given its ordinary meaning; however, where the term “unit” is being used in a form similar to the phrase “unit of marketing information,” such as here, the term is simply intended to define the subject matter to which it refers in a quantifiable context. For example, a “unit of marketing information” can represent one advertisement of a general group of advertisements of which the marketing information is comprised. Likewise, when a term such as “marketing information” comprises multiple elements, for example, advertisements and menus, the “unit of marketing information” can represent one advertisement or one menu of the general group of advertisements and menus. In some embodiments, the at least one computer database can be similar to one or more computer databases configured to provide the first data as described above with respect to system 100. In the same or different embodiments, the at least one computer system other than the first computer system can be similar to computer system 200 as described in further detail below.

Each unit of marketing information of the at least one unit of marketing information is indexed according to at least one selection category. Each selection category of the at least one selection category relates to at least one potential factor. As used herein, when the term “potential” is used to modify another term/phrase, the term/phrase is intended to represent the term/phrase it modifies in a hypothetical sense. For example, a “potential time of day” could represent one of any possible time of day that could reasonably exist or some sub-set thereof. Likewise, as used herein, when the term “actual” is used to modify another term/phrase, the term is intended to represent the term/phrase it modifies in an existing (e.g., provided) sense. For example, an “actual time of day” could represent one real example of the term that has been provided. In context, the “potential time of day” could comprise any time between 12:00 A.M. until 11:59 P.M. while an “actual time of day” could comprise 4:32 P.M. As a result, in some embodiments, one or more units of marketing information could be indexed to a “potential time of day” of 4:32 P.M. if the at least one potential factor comprises the “potential time of day.”

Moving forward with this basic framework in mind, the at least one potential factor comprises at least one potential operating condition of an electric vehicle supply equipment for an electric vehicle, at least one potential element of user data of a user profile of at least one user of the electric vehicle supply equipment, or at least one potential user input provided by the at least one user of the electric vehicle supply equipment. In some embodiments, the operating condition(s) can be similar to one or more of the operating conditions described above with respect to system 100. In the same or different embodiments, the element(s) of user data of the user profile can be similar to the at least one database input, and the user input(s) can be similar to the at least one user input, respectively, as described above for system 100.

Referring back to FIG. 5, system 500 comprises selection module 510 configured to run on the one or more processors. Selection module 510 is configured to receive the set of information from communication module 505. Selection module 510 comprises data aggregation module 511. Data aggregation module 511 is configured to receive at least one of: at least one actual operating condition of the electric vehicle supply equipment, at least one actual element of user data of the user profile data of the at least one user of the electric vehicle supply equipment, or at least one actual user input from the at least one user of the electric vehicle supply equipment.

Referring once again to FIG. 5, selection module 500 comprises associative module 512. Associative module 512 is configured to match: (a) each actual operating condition of the at least one actual operating condition that is received by data aggregation module 511 with the at least one potential operating condition to which the each actual operating condition of the at least one actual operating condition corresponds, (b) each actual element of user data of the user profile of the at least one actual element of user data of the user profile that is received by data aggregation module 511 with the at least one potential element of user data of the user profile to which the each actual element of user data of the user profile of the at least one actual element of user data of the user profile corresponds, and (c) each actual user input of the at least one user input received by data aggregation module 511 with the at least one potential user input to which the each actual user input of the at least one actual user input corresponds. For example, if the at least one potential operation condition of the electric vehicle supply equipment comprises at least one time at which the electric vehicle charging station is charging an electric vehicle, the at least one potential operation condition could comprise any time between 12:00 A.M. to 11:59 P.M. such as in the above provided example. Meanwhile, the actual operating condition could comprise 4:32 P.M. such as in the above provided example. Accordingly, associative module 512 could match the actual operation condition of 4:32 P.M. with the corresponding potential operation condition of 4:32 P.M.

For each potential operating condition of the at least one potential operating condition that is matched to each actual operating condition of the at least one actual operating condition, associative module 512 compiles a first information group comprising each unit of marketing information that is indexed with each selection category that relates to each potential operating condition matching each actual operating condition. Referring again to the earlier example, associative module 512 could compile the first information group such that the first information group comprises any unit of the marketing information that is indexed with the selection category relating to the potential operating condition of 4:32 P.M.

For each potential element of user data of the user profile that is matched to each actual element of user data of the user profile, associative module 512 compiles a second information group comprising each unit of marketing information that is indexed with each selection category that relates to each potential element of user data of the user profile matching each actual element of user data of the user profile.

For each potential user input of the at least one potential user input that is matched to the each actual user input of the at least one actual user input, associative module 512 compiles a third information group comprising each unit of marketing information of the at least one unit of marketing information that is indexed with each selection category that relates to each potential user input matching each actual user input of the at least one actual user input.

Referring again to FIG. 5, system 500 comprises combination module 515 configured to run on the one or more processors, to receive the first information group, the second information group, and the third information group, and to combine the first information group, the second information group, and the third information group into a fourth information group, wherein the relevant information comprises the fourth information group. Now, referring once again to the above example, similar approaches to this example could be conducted by associative module 512 to compile each of the second information group and the third information group such that combination module 515 could then proceed to provide the fourth information group by combining the first, second, and third information groups.

In many embodiments, system 500 can be configured to provide the relevant information from the set of information while: (a) the user is communicating with the electric vehicle supply equipment; and/or (b) the electric vehicle of the user is receiving a charge from the electric vehicle supply equipment.

In some embodiments, the set of information can further comprise at least one governmental message, and each governmental message can be indexed according to the at least one selection category. In the same or different embodiments, the first information group can further comprise each governmental message that is indexed with each selection category that relates to each potential operating condition matching each actual operating condition. In the same or different embodiments, the second information group can further comprise each governmental message that is indexed with each selection category that relates to each potential element of user data of the user profile matching each actual element of user data of the user profile. In the same or different embodiments, the third information group can further comprise each governmental message that is indexed with each selection category that relates to each potential user input matching each actual user input.

In various embodiments, the set of information can further comprise at least one news message, and each news message can be indexed according to the at least one selection category. In the same or different embodiments, the first information group further comprises each news message that is indexed with each selection category that relates to each potential operating condition matching each actual operating condition. In the same or different embodiments, the second information group can further comprise each news message that is indexed with each selection category that relates to each potential element of user data of the user profile matching each actual element of user data of the user profile. In the same or different embodiments, the third information group further comprises each news message that is indexed with each selection category that relates to each potential user input matching each actual user input.

In further embodiments, the set of information can further comprise at least one political message, and each political message can be indexed according to the at least one selection category. In the same or different embodiments, the first information group can further comprise each political message that is indexed with each selection category that relates to each potential operating condition matching each actual operating condition. In the same or different embodiments, the second information group can further comprise each political message that is indexed with each selection category that relates to each potential element of user data of the user profile matching each actual element of user data of the user profile. In the same or different embodiments, the third information group can further comprise each political message that is indexed with each selection category that relates to each potential user input matching each actual user input.

In other embodiments, the set of information can further comprise at least one public service announcement, and each public service announcement can be indexed according to the at least one selection category. In the same or different embodiments, the first information group can further comprise each public service announcement that is indexed with each selection category that relates to each potential operating condition matching each actual operating condition. In the same or different embodiments, the second information group can further comprise each public service announcement that is indexed with each selection category that relates to each potential element of user data of the user profile matching each actual element of user data of the user profile. In the same or different embodiments, the third information group can further comprise each public service announcement that is indexed with each selection category that relates to each potential user input matching each actual user input.

In many embodiments, the at least one potential operating condition can comprise at least one of a potential time at which the electric vehicle supply equipment is charging the electric vehicle or a potential length of an interval of time during which the electric vehicle supply equipment is charging the electric vehicle. In the same or different embodiments, the at least one actual operating condition can comprise at least one of an actual time at which the electric vehicle supply equipment is charging the electric vehicle or an actual length of an interval of time during which the electric vehicle supply equipment is charging the electric vehicle.

In various embodiments, at least one of the at least one potential user input or the at least one potential element of user data of the user profile of the at least one user of the electric vehicle supply equipment comprises at least one of a potential make of the electric vehicle, a potential model of the electric vehicle, a potential manufacturing year of the electric vehicle, a potential type of a rechargeable energy storage system of the electric vehicle, a potential type or size of at least one battery for the rechargeable energy storage system, a potential history of use of the rechargeable energy storage system, at least one potential preference of the user, at least one potential response of the user, at least one potential user inquiry of the user, a potential amount of time the user is willing to wait to receive a desired level of charge for the rechargeable energy storage system, a potential time at which the user requires the electric vehicle, a potential maximum price per unit of energy that the user is willing to pay, a potential maximum price that the user is willing to pay for charging the electric vehicle, a potential reservation for at least one interval of time during which to use the electric vehicle supply equipment, a potential reservation for at least one interval of time during which to use an alternative electric vehicle supply equipment, a potential odometer reading for the electric vehicle, a potential request that the electric vehicle supply equipment provide electricity from an alternative energy source, a potential desired level to which to charge the rechargeable energy storage system, a potential desired level to which to charge the at least one battery, at least one potential interest of the user, or at least one potential interest of a passenger of the electric vehicle. In the same or different embodiments, at least one of the at least one actual user input or the at least one actual element of user data of the user profile of the at least one user of the electric vehicle supply equipment comprises at least one of an actual make of the electric vehicle, an actual model of the electric vehicle, an actual manufacturing year of the electric vehicle, an actual type of the rechargeable energy storage system of the electric vehicle, an actual type or size of the at least one battery for the rechargeable energy storage system, an actual history of use of the rechargeable energy storage system, at least one actual preference of the user, at least one actual response of the user, at least one actual user inquiry of the user, an actual amount of time the user is willing to wait to receive the desired level of charge for the rechargeable energy storage system, an actual time at which the user requires the electric vehicle, an actual maximum price per unit of energy that the user is willing to pay, an actual maximum price that the user is willing to pay for charging the electric vehicle, an actual reservation for the at least one interval of time during which to use the electric vehicle supply equipment, an actual reservation for the at least one interval of time during which to use the alternative electric vehicle supply equipment, an actual odometer reading for the electric vehicle, an actual request that the electric vehicle supply equipment provide electricity from an alternative energy source, an actual desired level to which to charge the rechargeable energy storage system, an actual desired level to which to charge the at least one battery, at least one actual interest of the user, or at least one actual interest of a passenger of the electric vehicle.

In other embodiments, at least one of the at least one potential vehicle input of the electric vehicle of the user or the at least one potential element of user data of the user profile of the at least one user of the electric vehicle supply equipment comprises at least one of a potential make of the electric vehicle, a potential model of the electric vehicle, a potential manufacturing year of the electric vehicle, a potential type of rechargeable energy storage system of the electric vehicle, a potential type or size of a battery for the rechargeable energy storage system, a potential history of use of the rechargeable energy storage system, a potential odometer reading for the electric vehicle, a potential total capacity of charge for the rechargeable energy storage system, a potential total capacity of charge of a battery for the rechargeable energy storage system, a potential state of charge of the rechargeable energy storage system, a potential temperature of the rechargeable energy storage system (e.g., a potential temperature of all of the rechargeable energy storage system and/or one or more subsections or modules of the rechargeable energy storage system), or a potential electric voltage of the rechargeable energy storage system (e.g., a potential electric voltage of all of the rechargeable energy storage system and/or one or more subsections or modules of the rechargeable energy storage system). In the same or different embodiments, at least one of the at least one actual vehicle input of the electric vehicle of the user or the at least one actual element of user data of the user profile of the at least one user of the electric vehicle supply equipment comprises at least one of an actual make of the electric vehicle, an actual model of the electric vehicle, an actual manufacturing year of the electric vehicle, an actual type of rechargeable energy storage system of the electric vehicle, an actual type or size of the battery for the rechargeable energy storage system, an actual history of use of the rechargeable energy storage system, an actual odometer reading for the electric vehicle, an actual total capacity of charge for the rechargeable energy storage system, an actual total capacity of charge of the battery for the rechargeable energy storage system, an actual state of charge of the rechargeable energy storage system, an actual temperature of the rechargeable energy storage system (e.g., an actual temperature of all of the rechargeable energy storage system and/or one or more subsections or modules of the rechargeable energy storage system), or an actual electric voltage of the rechargeable energy storage system (e.g., an actual electric voltage of all of the rechargeable energy storage system and/or one or more subsections or modules of the rechargeable energy storage system).

In some embodiments, the at least one potential factor can further comprise at least one potential geographic location of the electric vehicle supply equipment. Data aggregation module 511 can be further configured to receive an actual geographic location of the electric vehicle supply equipment from one of the one or more first memory units of the first computer system or a global positioning system in electrical communication with aggregation module 511. In the same or different embodiments, associative module 512 can be further configured to match the actual geographic location of the electric vehicle supply equipment that is received by data aggregation module 511 with at least one of the at least one potential geographic location of the electric vehicle supply equipment being within a predetermined distance of the actual geographic location of the electric vehicle supply equipment. For each potential geographic location of the electric vehicle supply equipment being within the predetermined distance of the actual geographic location of the electric vehicle supply equipment, associative module 512 can compile a fifth information group comprising each unit of marketing information that is indexed with each selection category that relates to each potential geographic location of the electric vehicle supply equipment being within the predetermined distance of the actual geographic location of the electric vehicle supply equipment. In the same or different embodiments, combination module 515 can be further configured to receive the fifth information group and to combine the fifth information group with the relevant information such that the relevant information further comprises the fifth information group.

In other embodiments, the at least one potential factor can further comprise at least one potential vehicle input of the electric vehicle of the user. Data aggregation module 511 can be further configured to receive at least one actual vehicle input of the electric vehicle of the user from the electric vehicle of the user. In the same or different embodiments, associative module 512 can be further configured to match each actual vehicle input of the electric vehicle of the user that is received by the data aggregation module with the at least one potential vehicle input of the electric vehicle of the user to which the each actual vehicle input of the electric vehicle of the user corresponds. For each potential vehicle input of the electric vehicle of the user that is matched to each actual vehicle input of the electric vehicle of the user, associative module 512 can compile a sixth information group comprising each unit of marketing information that is indexed with each selection category that relates to each potential vehicle input of the electric vehicle of the user matching each actual vehicle input of the electric vehicle of the user. In the same or different embodiments, combination module 515 can be further configured to receive the sixth information group and to combine the sixth information group with the relevant information such that the relevant information further comprises the sixth information group.

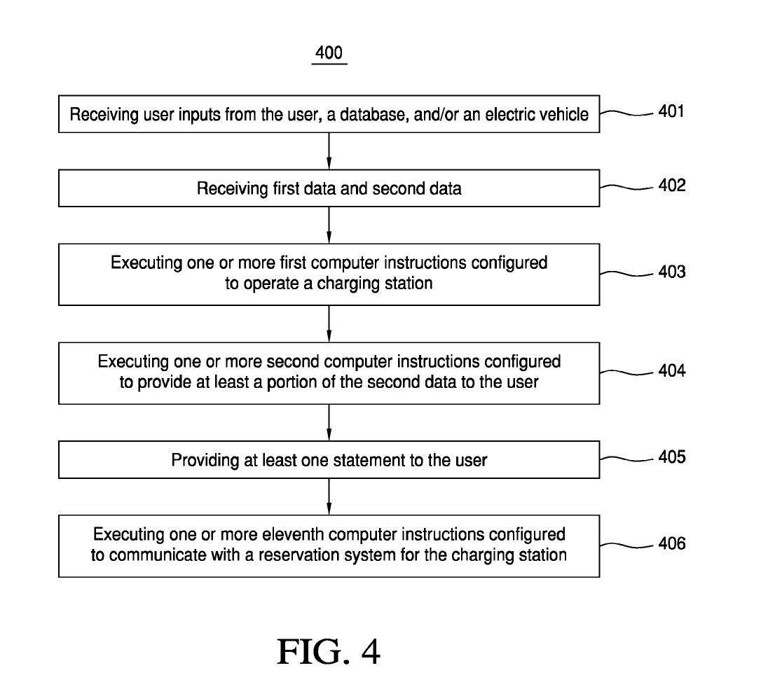

Returning now to the figures, FIG. 4 illustrates a flow chart for an embodiment of a method 400 for executing one or more computer programs using one or more processors of a computer system. Method 400 is merely exemplary and is not limited to the embodiments presented herein. Method 400 can be employed in many different embodiments or examples not specifically depicted or described herein. In some embodiments, the activities, the procedures, and/or the processes of method 400 can be performed in the order presented. In other embodiments, the activities, the procedures, and/or the processes of the method 400 can be performed in any other suitable order. In still other embodiments, one or more of the activities, the procedures, and/or the processes in method 400 can be combined or skipped.

In many embodiments, method 400 can be configured to operate in real time. In the same or different embodiments, at least one procedure, process, or activity in method 400 can occur upon the occurrence of an operation by at least one of or a combination of the other procedures, processes, or activities of method 400. In the same or different embodiments, at least one procedure, process, or activity in method 400 can occur upon the occurrence of an operation by a combination of the other procedures, processes, or activities of method 400 when the other procedures, processes, or activities of method 400 occur in a specified sequence. In still other embodiments, at least one procedure, process, or activity in method 400 can be configured to occur upon the passage of a certain interval of time.

Referring back to FIG. 4, method 400 comprises a procedure 401 of receiving user inputs from the user, a database, and/or an electric vehicle. In some embodiments, the user inputs can be similar to the at least one input of system 100 (FIG. 1). In the same or different embodiments, the user, the database, and/or the electric vehicle can be similar to the user, the computer database, and/or the vehicle of system 100 (FIG. 1), respectively.

Referring back to FIG. 4, method 400 comprises a procedure 402 of receiving first data and second data. The second data can be similar to the first data of system 100 (FIG. 1). In the same or different embodiments, the first data can be similar to the operating information of system 100 (FIG. 1).

Referring back to FIG. 4, method 400 comprises a procedure 403 of executing one or more first computer instructions configured to operate a charging station. The charging station can be similar to the electric vehicle charging station of system 100 (FIG. 1).

In some embodiments, executing the one or more first computer instructions configured to operate the charging station can comprise executing one or more third computer instructions configured to provide electricity from the charging station to a rechargeable energy storage system and/or executing one or more fourth computer instructions configured to provide electricity from the rechargeable energy storage system to the charging station. In the same or different embodiments, the one or more first computer instructions comprise the one or more third computer instructions and/or the one or more fourth computer instructions. In some embodiments, the rechargeable energy storage system can comprise a rechargeable energy storage system for the electric vehicle.

Referring back to FIG. 4, method 400 comprises a procedure 404 of executing one or more second computer instructions configured to provide at least a portion of the second data to the user. In some embodiments, executing the one or more second computer instructions configured to provide the at least the portion of the second data to the user can comprise using at least a first electronic display to display the at least the portion of the second data. In the same or different embodiments, the display can comprise one or more displays similar to the one or more displays of system 100 (FIG. 1). In some embodiments, executing one or more second computer instructions configured to provide at least a portion of the second data to the user can be similar to selecting at least a portion of the first data to provide to the user based on at least one of the at least one user input, the operating conditions, or a geographic location of the electric vehicle charging station, as described above with respect to system 100 (FIG. 1) and/or can be similar to system 600 (FIG. 6).

In some embodiments, executing the one or more second computer instructions configured to provide the at least the portion of the second data can comprise executing one or more fifth computer instructions configured to determine the at least the portion of the second data that is relevant to the user and/or the electric vehicle. In the same or different embodiments, the one or more second computer instructions comprise the one or more fifth computer instructions. In the same or different embodiments, the executing one or more fifth computer instructions configured to determine the at least the portion of the second data that is relevant to the user and/or the electric vehicle can be similar to selecting at least a portion of the first data to provide to the user based on at least one of the at least one user input, the operating conditions, or a geographic location of the electric vehicle charging station, as described above with respect to system 100 (FIG. 1) and/or can be similar to system 600 (FIG. 6).

In some examples, the user inputs can comprise a desired level of charge and an existing level of charge. In the same or different embodiments, executing the one or more first computer instructions configured to operate the charging station can comprise executing one or more sixth computer instructions configured to calculate an approximate quantity of time remaining to provide the desired level of charge. In the same or different embodiments, executing the one or more fifth computer instructions configured to determine the at least the portion of the second data that is relevant to the at least one of the user or the vehicle can comprise executing one or more seventh computer instructions configured to compile the at least the portion of the second data based on the approximate quantity of time remaining to provide the desired level of charge from the existing level of charge. In the same or different embodiments, the one or more first computer instructions comprise the one or more sixth computer instructions, and/or the one or more fifth computer instructions comprise the one or more seventh computer instructions.

In other examples, executing the one or more fifth computer instructions configured to determine the at least the portion of the second data that is relevant to the at least one of the user or the electric vehicle can comprise executing one or more eighth computer instructions configured to determine a location of the user, the electric vehicle, and/or the charging station. In the same or different embodiments, executing the one or more fifth computer instructions configured to determine the at least the portion of the second data that is relevant to the at least one of the user or the electric vehicle can comprise executing one or more ninth computer instructions configured to compile the at least the portion of the second data based on the location of the user, the electric vehicle, and/or the charging station. In the same or different embodiments, the one or more fifth computer instructions comprise the one or more eighth computer instructions and/or the one or more ninth computer instructions.

Referring back to FIG. 4, method 400 can comprise a procedure 405 of providing at least one statement to the user. In some embodiments, the at least one statement can be similar to the one or more outputs of system 100 (FIG. 1).

In various examples, the user inputs can comprise at least one response to the at least one statement. In the same or different embodiments, executing the one or more fifth computer instructions configured to determine the at least the portion of the second data that is relevant to the user and/or the electric vehicle can comprise executing one or more tenth computer instructions configured to compile the at least the portion of the second data based on the at least one response. In the same or different embodiments, the one or more fifth computer instructions comprise the one or more tenth computer instructions.

Referring back to FIG. 4, method 400 can comprise a procedure 406 of executing one or more eleventh computer instructions configured to communicate with a reservation system for the charging station. In some embodiments, the reservation system can be similar to reservation module 162 of system 100 (FIG. 1).

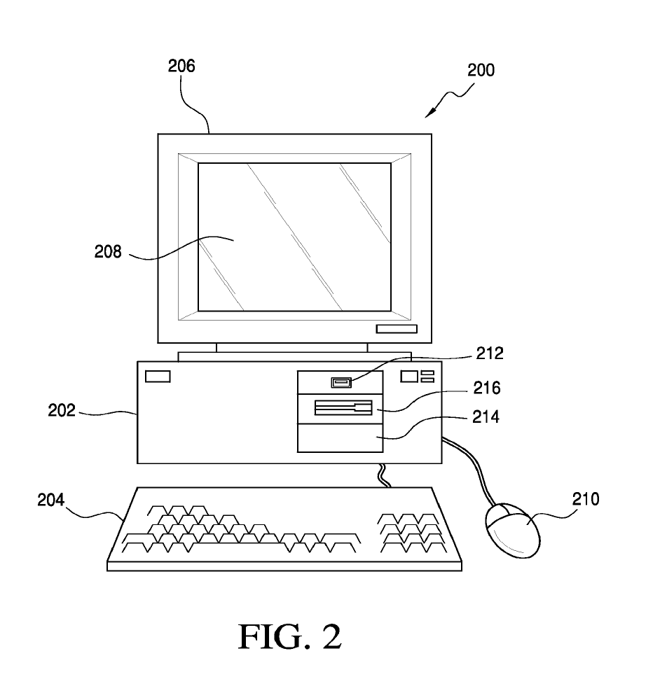

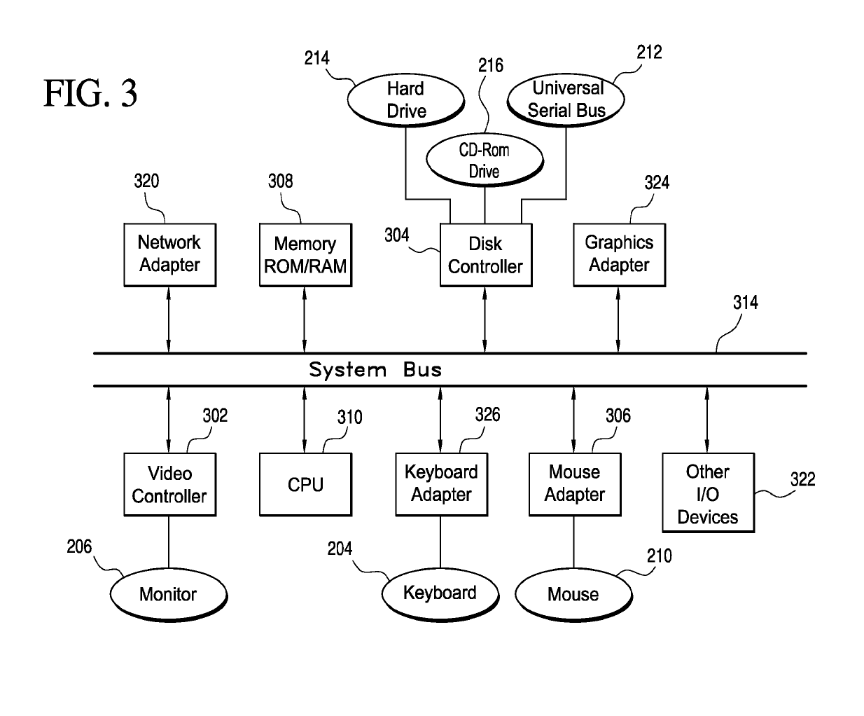

FIG. 2 illustrates an embodiment of a computer system 200 that is suitable for implementing an embodiment of at least a portion of system 100 (FIG. 1) of the various embodiments of the present invention. Computer system 200 includes a chassis 202 containing one or more circuit boards (not shown), a Universal Serial Bus (USB) 212, a Compact Disc Read-Only Memory (CD-ROM) and/or Digital Video Disc (DVD) drive 216, and a hard drive 214. A representative block diagram of the elements included on the circuit boards inside chassis 202 is shown in FIG. 3. A central processing unit (CPU) 310 in FIG. 3 is coupled to a system bus 314 in FIG. 3. In various embodiments, the architecture of CPU 310 can be compliant with any of a variety of commercially distributed architecture families.

System bus 314 also is coupled to memory 308 that includes both read only memory (ROM) and random access memory (RAM). Non-volatile portions of memory 308 or the ROM can be encoded with a boot code sequence suitable for restoring computer system 200 (FIG. 2) to a functional state after a system reset. In addition, memory 308 can include microcode such as a Basic Input-Output System (BIOS). In some examples, the memory unit of the various embodiments disclosed herein can include memory 308, USB 212 (FIGS. 2 and 3), hard drive 214 (FIGS. 2 and 3), and/or CD-ROM or DVD drive 216 (FIGS. 2 and 3). In the same or different examples, the memory unit of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files.

In the depicted embodiment of FIG. 3, various I/O devices such as a disk controller 304, a graphics adapter 324, a video controller 302, a keyboard adapter 326, a mouse adapter 306, a network adapter 320, and other I/O devices 322 can be coupled to system bus 314. Keyboard adapter 326 and mouse adapter 306 are coupled to a keyboard 204 (FIGS. 2 and 3) and a mouse 210 (FIGS. 2 and 3), respectively, of computer system 200 (FIG. 2). While graphics adapter 324 and video controller 302 are indicated as distinct units in FIG. 3, video controller 302 can be integrated into graphics adapter 324, or vice versa in other embodiments. Video controller 302 is suitable for refreshing a monitor 206 (FIGS. 2 and 3) to display images on a screen 208 (FIG. 2) of computer system 200 (FIG. 2). Disk controller 304 can control hard drive 214 (FIGS. 2 and 3), USB 212 (FIGS. 2 and 3), and CD-ROM or DVD drive 216 (FIGS. 2 and 3). In other embodiments, distinct units can be used to control each of these devices separately.

In some embodiments, network adapter 320 can be part of a WNIC (wireless network interface controller) card (not shown) plugged or coupled to an expansion port (not shown) in computer system 200. In other embodiments, the WNIC card can be a wireless network card built into computer system 200. A wireless network adapter can be built into computer system 200 by having wireless Ethernet capabilities integrated into the motherboard chipset (not shown), or implemented via a dedicated wireless Ethernet chip (not shown), connected through the PCI (peripheral component interconnector) or a PCI express bus. In other embodiments, network adapter 320 can be a wired network adapter.

Although many other components of computer system 200 (FIG. 2) are not shown, such components and their interconnection are well known to those of ordinary skill in the art. Accordingly, further details concerning the construction and composition of computer system 200 and the circuit boards inside chassis 202 (FIG. 2) need not be discussed herein.

When computer system 200 in FIG. 2 is running, program instructions stored on a USB equipped electronic device connected to USB 212, on a CD-ROM or DVD in CD-ROM and/or DVD drive 216, on hard drive 214, or in memory 308 (FIG. 3) are executed by CPU 310 (FIG. 3). A portion of the program instructions, stored on these devices, can be suitable for carrying out method 400 (FIG. 4) and one or more functions of system 100 (FIG. 1).

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 401-406 may be comprised of many different activities, processes, and procedures and be performed by many different modules, in many different orders, that any element of FIGS. 1-5 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A method of providing relevant information from a set of information, the method being implemented via execution of computer instructions configured to run at one or more processing modules and configured to be stored at one or more non-transitory memory storage modules, the method comprising:
executing one or more first computer instructions configured to receive the set of information, wherein the set of information comprises at least one unit of marketing information indexed according to at least one selection category, the at least one selection category relating to at least one potential factor, and the at least one potential factor comprising at least one of: (a) at least one potential operating condition of an electric vehicle supply equipment, (b) at least one potential element of user data of an user profile, or (c) at least one potential user input;
executing one or more second computer instructions configured to receive at least one of: (a) at least one actual operating condition of the electric vehicle supply equipment, (b) at least one actual element of user data of the user profile, or (c) at least one actual user input;
if the at least one potential factor comprises the at least one potential operation condition of the electric vehicle supply equipment and if the at least one actual operating condition of the electric vehicle supply equipment is received, executing one or more third computer instructions configured to match the at least one actual operating condition with one or more of the at least one potential operation condition;
if the at least one potential factor comprises the at least one potential element of user data of the user profile and if the at least one actual element of user data of the user profile is received, executing one or more fourth computer instructions configured to match the at least one actual element of user data of the user profile with one or more of the at least one potential element of user data of the user profile;
if the at least one potential factor comprises the at least one potential user input and if the at least one actual user input is received, executing one or more fifth computer instructions configured to match the at least one actual user input with one or more of the at least one potential user input;
if the one or more third computer instructions are executed, executing one or more sixth computer instructions configured to compile a first information group, the first information group comprising each unit of marketing information of the at least one unit of marketing information that is indexed according to the at least one selection category that relates to the at least one potential operating condition comprising the one or more of the at least one potential operation condition;
if the one or more fourth computer instructions are executed, executing one or more seventh computer instructions configured to compile a second information group, the second information group comprising each unit of marketing information of the at least one unit of marketing information that is indexed according to the at least one selection category that relates to the at least one potential operating condition comprising the one or more of the at least one potential user input;
if the one or more fifth computer instructions are executed, executing one or more eighth computer instructions configured to compile a third information group, the third information group comprising each unit of marketing information of the at least one unit of marketing information that is indexed according to the at least one selection category that relates to the at least one potential operating condition comprising the one or more of the at least one potential user input; and
executing one or more ninth computer instructions configured to combine at least one of the first information group, the second information group, or the third information group into a fourth information group, wherein the relevant information comprises the fourth information group.

2) The method of claim 1 further comprising:
executing one or more tenth computer instructions configured to provide the relevant information to a user of the electric vehicle supply equipment.

3) The method of claim 1 wherein:
the set of information further comprises at least one governmental message indexed according to the at least one selection category;
the first information group further comprises each governmental message of the at least one governmental message that is indexed according to the at least one selection category that relates to the at least one potential operating condition comprising the one or more of the at least one potential operation condition;
the second information group further comprises each governmental message of the at least one governmental message that is indexed according to the at least one selection category that relates to the at least one potential operating condition comprising the one or more of the at least one potential user input;
and
the third information group further comprises each governmental message of the at least one governmental message that is indexed according to the at least one selection category that relates to the at least one potential operating condition comprising the one or more of the at least one potential user input.

4) The method of claim 1 wherein:
the set of information further comprises at least one news message indexed according to the at least one selection category;
the first information group further comprises each news message of the at least one news message that is indexed according to the at least one selection category that relates to the at least one potential operating condition comprising the one or more of the at least one potential operation condition;
the second information group further comprises each news message of the at least one news message that is indexed according to the at least one selection category that relates to the at least one potential operating condition comprising the one or more of the at least one potential user input;
and
the third information group further comprises each news message of the at least one news message that is indexed according to the at least one selection category that relates to the at least one potential operating condition comprising the one or more of the at least one potential user input.

5) The method of claim 1 wherein:
the set of information further comprises at least one political message indexed according to the at least one selection category;
the first information group further comprises each political message of the at least one political message that is indexed according to the at least one selection category that relates to the at least one potential operating condition comprising the one or more of the at least one potential operation condition;
the second information group further comprises each political message of the at least one political message that is indexed according to the at least one selection category that relates to the at least one potential operating condition comprising the one or more of the at least one potential user input;
and
the third information group further comprises each political message of the at least one political message that is indexed according to the at least one selection category that relates to the at least one potential operating condition comprising the one or more of the at least one potential user input.

6) The method of claim 1 wherein:
the set of information further comprises at least one public service announcement indexed according to the at least one selection category;
the first information group further comprises each public service announcement of the at least one public service announcement that is indexed according to the at least one selection category that relates to the at least one potential operating condition comprising the one or more of the at least one potential operation condition;
the second information group further comprises each public service announcement of the at least one public service announcement that is indexed according to the at least one selection category that relates to the at least one potential operating condition comprising the one or more of the at least one potential user input;
and
the third information group further comprises each public service announcement of the at least one public service announcement that is indexed according to the at least one selection category that relates to the at least one potential operating condition comprising the one or more of the at least one potential user input.

7) The method of claim 1 wherein:
the at least one potential operating condition comprises at least one of:
a potential time at which the electric vehicle supply equipment is at least one of coupled with or charging an electric vehicle; or
a potential length of an interval of time during which the electric vehicle supply equipment is at least one of coupled with or charging the electric vehicle;
and
the at least one actual operating condition comprises at least one of:
an actual time at which the electric vehicle supply equipment is at least one of coupled with or charging with the electric vehicle; or
an actual length of an interval of time during which the electric vehicle supply equipment is at least one of coupled with or charging the electric vehicle.

8) The method of claim 1 wherein:
at least one of the at least one potential user input or the at least one potential element of user data of the user profile comprises at least one of:
a potential make of an electric vehicle;
a potential model of the electric vehicle;
a potential manufacturing year of the electric vehicle;
a potential type of a rechargeable energy storage system of the electric vehicle;
a potential type or size of at least one battery for the rechargeable energy storage system;
a potential history of use of the rechargeable energy storage system;
at least one potential preference of a user of the electric vehicle supply equipment;
at least one potential response of the user;
at least one potential user inquiry of the user;
a potential amount of time the user is willing to wait to receive a desired level of charge for the rechargeable energy storage system;
a potential time at which the user requires the electric vehicle;
a potential maximum price per unit of energy that the user is willing to pay;
a potential maximum price that the user is willing to pay for charging the electric vehicle;
a potential reservation for at least one interval of time during which to use the electric vehicle supply equipment;
a potential reservation for at least one interval of time during which to use an alternative electric vehicle supply equipment;
a potential odometer reading for the electric vehicle;
a potential request that the electric vehicle supply equipment provide electricity from an alternative energy source;
a potential desired level to which to charge the rechargeable energy storage system;
a potential desired level to which to charge the at least one battery;
at least one potential interest of the user; or
at least one potential interest of a passenger of the electric vehicle;
and
at least one of the at least one actual user input or the at least one actual element of user data of the user profile comprises at least one of:
an actual make of the electric vehicle;
an actual model of the electric vehicle;
an actual manufacturing year of the electric vehicle;
an actual type of the rechargeable energy storage system of the electric vehicle;
an actual type or size of the at least one battery for the rechargeable energy storage system;
an actual history of use of the rechargeable energy storage system;
at least one actual preference of the user;
at least one actual response of the user;
at least one actual user inquiry of the user;
an actual amount of time the user is willing to wait to receive the desired level of charge for the rechargeable energy storage system;
an actual time at which the user requires the electric vehicle;
an actual maximum price per unit of energy that the user is willing to pay;
an actual maximum price that the user is willing to pay for charging the electric vehicle;
an actual reservation for the at least one interval of time during which to use the electric vehicle supply equipment;
an actual reservation for the at least one interval of time during which to use the alternative electric vehicle supply equipment;
an actual odometer reading for the electric vehicle;
an actual request that the electric vehicle supply equipment provide electricity from an alternative energy source;
an actual desired level to which to charge the rechargeable energy storage system;
an actual desired level to which to charge the at least one battery;
at least one actual interest of the user; or
at least one actual interest of a passenger of the electric vehicle.

9) The method of claim 1 wherein:
the at least one potential factor further comprises at least one potential geographic location of the electric vehicle supply equipment; and
the method further comprises:
executing one or more tenth computer instructions configured to receive an actual geographic location of the electric vehicle supply equipment;
if the at least one potential factor comprises the at least one potential geographic location of the electric vehicle supply equipment, executing one or more eleventh computer instructions configured to match the actual geographic location of the electric vehicle supply equipment with one or more of the at least one potential geographic location of the electric vehicle supply equipment;
if the one or more eleventh computer instructions are executed, executing one or more twelfth computer instructions configured to compile a fifth information group, the fifth information group comprising each unit of marketing information of the at least one unit of marketing information that is indexed according to the at least one selection category that relates to the at least one potential operating condition comprising the one or more of the at least one potential geographic location of the electric vehicle supply equipment;
if the one or more twelfth computer instructions are executed, executing one or more thirteenth computer instructions configured to combine the fifth information group into the fourth information group.

10) The method of claim 1 wherein:
the at least one potential factor further comprises at least one potential vehicle input; and
the method further comprises:
executing one or more tenth computer instructions configured to receive an actual vehicle input;
if the at least one potential factor comprises the at least one potential vehicle input, executing one or more eleventh computer instructions configured to match the actual vehicle input with one or more of the at least one potential vehicle input;
if the one or more eleventh computer instructions are executed, executing one or more twelfth computer instructions configured to compile a fifth information group, the fifth information group comprising each unit of marketing information of the at least one unit of marketing information that is indexed according to the at least one selection category that relates to the at least one potential operating condition comprising the one or more of the at least one potential vehicle input;
if the one or more twelfth computer instructions are executed, executing one or more thirteenth computer instructions configured to combine the fifth information group into the fourth information group.

11) A method being implemented via execution of computer instructions configured to run at one or more processing modules and configured to be stored at one or more non-transitory memory storage modules, the method comprising:
executing one or more first computer instructions configured to receive at least one user input from at least one of a user of an electric vehicle charging station, a user database, or an electric vehicle, the at least one user input comprising a desired level of charge and an existing level of charge;
executing one or more second computer instructions configured to receive first data and second data, wherein the second data comprises marketing information;
executing one or more third computer instructions configured to determine at least a portion of the second data that is relevant to at least one of the user or the electric vehicle; and
executing one or more fourth computer instructions configured to provide to the user the at least the portion of the second data;
wherein:
executing the one or more third computer instructions comprises:
executing one or more fifth computer instructions configured to calculate an approximate quantity of time remaining to provide the desired level of charge; and
executing one or more sixth computer instructions configured to compile the at least the portion of the second data based on the approximate quantity of time remaining to provide the desired level of charge from the existing level of charge.

12) The method of claim 11 further comprising:
executing one or more seventh computer instructions configured to provide electricity to a rechargeable energy storage system of the electric vehicle from the electric vehicle charging station.

13) The method of claim 11 wherein:
executing the one or more third computer instructions comprises:
executing one or more seventh computer instructions configured to determine a location of at least one of the user, the electric vehicle, or the electric vehicle charging station; and
executing one or more eighth computer instructions configured to compile the at least the portion of the second data based on the location of the at least one of the user, the electric vehicle, or the electric vehicle charging station.

14) The method of claim 11 wherein:
executing the one or more third computer instructions comprises:
executing one or more seventh computer instructions configured to provide a statement to the user;
executing one or more eighth computer instructions configured to receive at least one response to the statement; and
executing one or more ninth computer instructions configured to compile the at least the portion of the second data based on the at least one response to the statement.

15) The method of claim 11 wherein:
executing the one or more fourth computer instructions comprises executing one or more seventh computer instructions configured to display at an electronic display the at least the portion of the second data to the user.

16) A system comprising:
a communications module configured to receive (a) at least one user input from at least one of a user of an electric vehicle charging station, a user database, or an electric vehicle, the at least one user input comprising a desired level of charge and an existing level of charge, (b) first data, and (c) second data, the second data comprising marketing information;
an operations module configured to communicate with the communications module and to determine at least a portion of the second data that is relevant to at least one of the user or the electric vehicle; and
an output module configured to communicate with the communications module and the operations module and to provide to the user, the at least the portion of the second data;
wherein:
the operations module is configured to (a) calculate an approximate quantity of time remaining to provide the desired level of charge, and (b) compile the at least the portion of the second data based on the approximate quantity of time remaining to provide the desired level of charge from the existing level of charge.

17) The system of claim 16 further comprising:
the electric vehicle charging station, the electric vehicle charging station comprising at least one of the communications module or the output module.

18) The system of claim 16 wherein:
the operations module is configured to (a) determine a location of at least one of the user, the electric vehicle, or the electric vehicle charging station, and (b) compile the at least the portion of the second data based on the location of the at least one of the user, the electric vehicle, or the electric vehicle charging station.

19) The system of claim 16 wherein:
the communications module is configured to (a) provide a statement to the user, and (b) receive at least one response to the statement; and
the operations module is configured to compile the at least the portion of the second data based on the at least one response to the statement.

20) The system of claim 16 wherein:
the output module comprises an electronic display, the output module being configured to display at the electronic display the at least the portion of the second data to the user at the electronic display.
